(19) United States
(12) Patent Application Publication
(10) Pub. No.: US 2002/0090154 A1
(43) Pub. Date: Jul. 11, 2002

(54) Self-lubricating bearing

(76) Inventor: Hans Murray, Djursholm (SE)

Correspondence Address: MARSHALL, GERSTEIN & BORUN, 6300 SEARS TOWER, 233 SOUTH WACKER, CHICAGO, IL, 60606-6357, US

(21) Appl. No.: 09/920,377

(22) Filed: Aug. 1, 2001

Related U.S. Application Data
(63) Continuation of application No. PCT/SE00/00184, filed on Jan. 31, 2000.

(30) Foreign Application Priority Data
Feb. 4, 1999 (SE) 9900386-5

(51) Int. Cl. F16C 23/04

(52) U.S. Cl. 384/192; 384/208

(57) ABSTRACT

Self-adjustable, self-lubricating joint or sliding bearing unit incorporating an inner ring having an outer contour, which together with an outer part designed in a complementary manner and having a main axial direction is designed to be able to permit angular deviations between the axis direction of the inner ring and the axis direction of the outer part, and where the outer part is manufactured from a porous, preferably sintered material that is compressed about the inner part, and having an ability of bleeding oil during operation of the joint or bearing unit for lubrication of the contact surfaces facing each other, whereby the inner part is provided with irregularities in the form of grooves and/or chutes, indentations and/or bridges, arranged to eliminate between the contact surfaces and uneven pressure distribution in the oil caused by a laminar oil flow.

The present invention refers to a self-lubricating bearing, of the type defined in the preamble of claim 1.

### BACKGROUND OF THE INVENTION

Sliding bearings for supporting rotatable shafts conventionally incorporates only one bearing member, which co-operates directly with the cylindrical shaft, which is commonly ground and tempered. Usually this bearing member is manufactured from bearing metal or sintered material. The bearing member, hereinafter referred to as the outer ring, has a bearing bore for the shaft, which bore car, be a through-hole or a blind hole, and which is usually positioned in the centre of the of the bearing body. Such bearings can be adapted to take up purely radial loads, but they might also be designed as spherical bearings with the ability of making a self-aligning torsional movement for compensating for misalignment between the shaft and the bore of the outer ring. In such embodiments the fitting of the outer ring is equipped with a spherical or part-spherical inner surface, which is allowed to co-operate with an inner bearing part, which is attachable to the shaft and having a corresponding spherical or part-spherical outer surface.

An example of such a structure is shown in U.S. Pat. No. 4,014,596, wherein an externally spherical bearing par: is prevented from rotation relative to a surrounding housing, by co-operation between projections and grooves. In order to reduce the friction and thereby the heating at sliding between the outer side of the shaft and the surrounding wall of the corresponding hole, the shaft is tempered and machined to a high surface finish, which highly contributes to high manufacturing and machining costs.

In NL-A-6902926 is disclosed a method for manufacturing a self-lubricating, self-aligning spherical bearing. This self-lubricating, spherical bearing forms a unit wherein one part is rotatable and the other part is kept immobile. The difference between that bearing and other self-lubricating bearings is that the still-standing part, or the outer ring corresponds to a normal self-lubricating bearing and the inner ring corresponds to the shaft. For that reason the shaft does not have to have a particularly high surface finish and therefore must not be neither ground or tempered. The function of the bearing thus is like that of a spherical rolling bearing with the difference that it has no rolling bodies.

At the method according to the older publication is manufactured a self-aligning joint or bearing unit of the sliding type incorporating an outer part made of a porous material, such as sinter metal, steel or iron powder, The structure of the porous material gives a self-lubricating outer part. The inner part is spherical and equipped with an opening through which is arranged a mandrel having a certain excessive dimension. The inner part with mandrel is positioned inside the sleeve-like outer part, which thereupon by means of a pressure device is compressed axially, whereby is obtained a spherical sliding surface, which osculates to and engages against the sliding surface of the inner part. The sintered ring is charged with a lubricant, which later on during operation gradually leaves the sintered ring in the form of an oil, which “bleeds”.

Such a joint or bearing unit represents a well functioning and simple unit e.g. for caster units for customer's trolleys and the like. At higher relative rotational speeds there is however a tendency for an oil pressure to be built up at the output side at the lower part of the inner ring and the outer ring and at the input side a sub-pressure. This means that a laminar flow pattern is obtained in the oil, which will have a speed-reducing effect. At applications for higher loads it might therefore be of interest to improve the self-lubricating properties further, and it is furthermore also desirable to to be able to design the unit in such a manner that it in such a simple and non space-requiring manner as possible is adaptable to different applications wherein it can be used.

Finally it is a desire to be able to provide bearings of this type, which have a larger or smaller possibility, adapted to the application, of allowing angular deviations between the centre lines of th inner ring and of the outer ring.

A purpose of the present invention is to provide such a joint or bearing unit, by which the above problems of uneven distribution of the oil bleeding out of the outer ring have been eliminated and this has been obtained in that the unit has been given the features defined in claim 1.

Another purpose of the invention is to offer such a joint or bearing unit, which is well adaptable to different applications, which has been obtained in that the unit has been given the features defined in claim 3.

A further purpose of the invention is to offer a bearing of this kind, which permits an optional, bigger or smaller degree of angular deviation between the centre axes of the inner ring and the outer ring and this has been obtained by the features defined in the characterizing part of claim 4.

Hereinafter the invention will be further clarified with reference to the accompanying drawings, which show a number exemplifying but no: limiting embodiments of a joint or bearing unit in accordance with the invention.

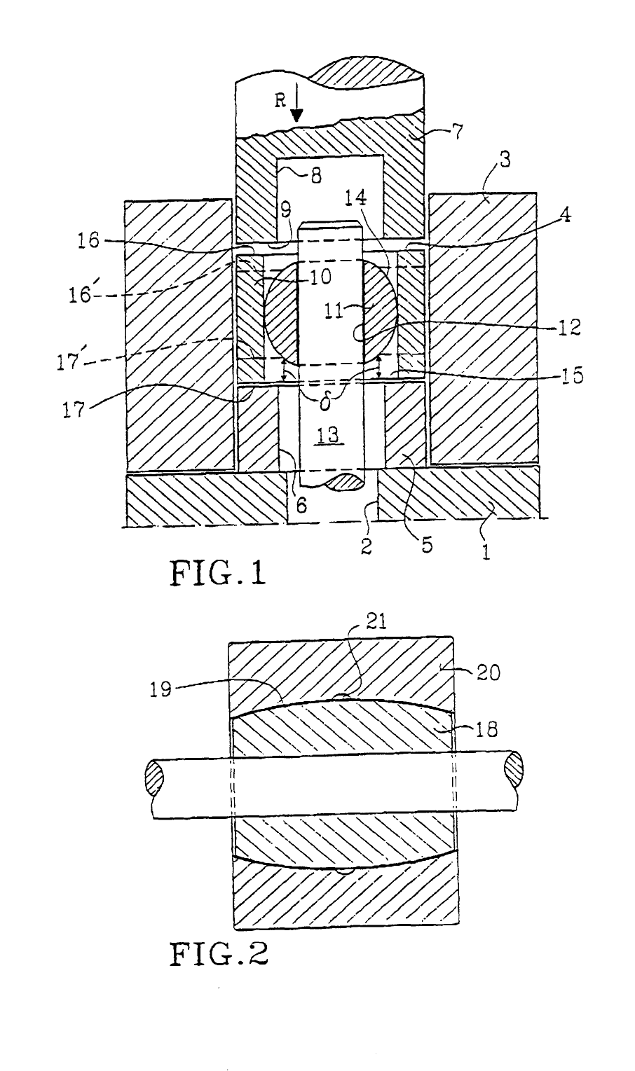

FIG. 1 is a schematical illustration in cross section of a press device during schematic manufacture of a joint or bearing unit according to an embodiment of the present invention.

FIG. 2 is a cross section of an embodiment of a self-lubricating bearing according to the invention.

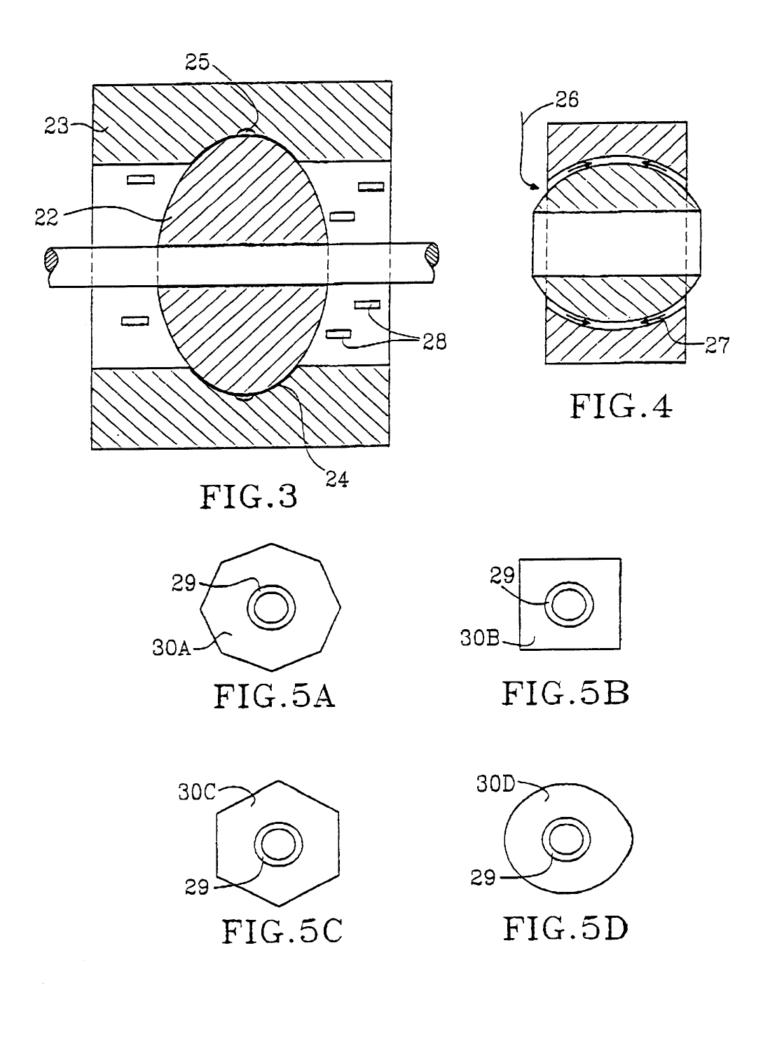

FIG. 3 is a corresponding view of an alternative embodiment according to the invention.

FIG. 4 illustrates the flow of the lubricating oil in a spherical embodiment of a bearing according to the present invention, and

FIG. 5A-5D illustrate schematically different methods according to which the bearing according to the present invention can be provided with different external designs adapted to co-operating components.

In FIG. 1 is shown schematically a cross section through a simplified press device having a base 1 with a central opening 2 and a die 3 positioned on the base and having a cylindrical press chamber 4 with a lower support ring 5 with a central through-bore 6 positioned on top of the base. A cylindrical punch 7 with a central recess 8 can be urged axially in the direction of the arrow R into the upper part of the press chamber 4. Between the lower side 9 of the punch and the upper side of the support ring 5, there is inserted two bearing parts, which in the press device shall be interconnected in order to form a continuous bearing unit, These two bearing parts incorporates a sleeve-shaped outer part 10 of porous material and an annular inner part 11 pressed into the interior of the sleeve with a light fit, and having an axial central through-hole 12 for a flaring mandrel 13. The inner part 11 is hereby preferably manufactured from a homogeneous material, preferably a material which can be heat treated to a high surface hardness, such a ball bearing steel. In the embodiment illustrated the inner part 11 has a convex curved, spherical outer surface 14.

The punch 7 is urged in to the press chamber 4 whereby the lower side 9 of the punch moves in a direction towards the upper side 15 of the support ring 5, The bearing outer part 10, consisting of a porous material thereby will be compressed axially under deformation of the material in the outer part, the material of which thereby under cold flow will move inwardly towards the outer surface 14 or the inner part, whereby the outer part will adapt itself to the hard outer surface of the inner part. When the press operation is terminated the upper and lower end surfaces 16 and 17 resp., of the outer ring have been moved the distance σ toward each other and will be situated in the new positions 16′ and 17′, resp. With the design of the inner part 11 in this exemplifying drawing figure, the resulting joint or bearing unit will have the appearance illustrated in a schematical cross section in FIG. 4, where the inner part is enclosed in the outer part in a shape bound manner.

It is emphasized that the press device illustrated in the drawing figure is only an elucidating example which is not claiming to show a complete or even dimensional correct machine.

The unit made in accordance with FIG. 1 and illustrated in FIG. 4 forms a true spherical design of the outside of the inner part and therefore results in a “spherical” self-alignment between the parts in the unit.

In FIG. 2 is illustrated an alternative embodiment which is encompassed by the present invention and wherein the inner part la is designed with a convexly curved “barrel-shaped” outer surface 19. With corresponding manufacturing conditions, as illustrated in FIG. 1, here the outer ring 20 made from a porous material, e.g. sintered iron powder, will adapt itself to the shape of the inner part. In such a case is obtained a bearing unit with an adjustability, with is determined by the relation between the axial length of the outer ring and the curvature of he inner ring, and which is smaller than that illustrated in FIG. 4, but which will simultaneously give a higher load carrying capacity to the bearing. By adapting the curvature form of the inner ring and the axial length of the bearing to each other, it thereby is possible to adapt the self-alignment degree to a large extent and also the load-carrying capacity in accordance with the application for which the bearing or the joint unit shall be used. Preferably the inner surface of the outer ring is provided with a centrally provided circumferential groove-shaped indentation 21, which to some extent improves the distribution of the lubricant, with which the outer ring made from porous material has been impregnated, and which during operation of the bearing bleeds out and thereby shall form a sufficient oil film for lubricating the contact soots between inner and outer part.

In FIG. 3 is illustrated one further embodiment of a bearing unit according to the invention, whereby the inner part has been designed as a substantially elliptical rotational body 22, which in a manner as before at manufacture of the assembled bearing has given an outer ring 23 having an internal race track 24, which is adapted after the outer shape of the inner part. Also in this case there is a circumferential groove 25 in the inner side of the outer ring for distribution of oil bleeding from the material of the outer ring during operation and load. As illustrated in FIG. 4 there is a tendency that a flow 26, 27 will arise between the co-operating surfaces, which can result in a pressure build at parts of the bearing and sub-pressure at other, which can give rise to insufficient lubrication in parts of the contact surfaces.

In order to avoid this the inner surface of the outer part 23 may preferably, as illustrated in FIG. 3, be equipped with flutes, recesses or other irregularities 28, which counteract the laminar flow, which can give rise to such an undesirable uneven pressure distribution within the bearing. Such irregularities can be made as recesses or bridges e.g. in that the inner surface of the initial material is provided with a tooth-like profile (not shown), or in that at joining of the two parts a stamped out film is pushed in between the inner part and the outer part. At compression the film will hereby make an indentation in the powder material, which gives a sufficiently uneven surface for creating turbulent oil flows, which reduce the pressure differences in th oil at different Darts of the periphery of the bearing. Such irregularities can also be shaped as a orange peel surface on a tempered outer surface of the inner part.

As illustrated in FIGS. 5A-5D it is also suggested that the outer contour of the joint or bearing unit is designed with a shape, which is adapted to that or those machine components with which the unit shall be mounted and cooperate with, and by the manufacturing technique used is it easy to make the outer contour of the outer part around a spherical, part spherical, barrel-shaped or e.g. an elliptic inner part 29, octagonal 30A, quadrangular 30B, hexagonal 30C or circular 30D, without this influencing the inter-engaging surfaces of the inner and outer parts.

The invention is not limited to embodiments schematically illustrated in the accompanying drawings and described in connection thereto but the invention can be varied and modified within the scope of the following claims.

1. Self-adjustable, self-lubricating joint or sliding bearing unit incorporating an inner ring (11,18,22,29) having an outer contour (14, 19, 24), which together with an outer part (10,20,22, 30A,30B,30C,30D) designed in a complementary manner and having a main axial direction is designed to be able to permit angular deviations between the axis direction of the inner ring and the axis direction of the outer part, and where the outer part is manufactured from a porous, preferably sintered material that is compressed about the inner part, and having an ability of bleeding oil during operation of the joint or bearing unit for lubrication of the contact surfaces facing each other,
characterized therein,
that the inner part (20, 23) is provided with irregularities (21,25,28) in the form of grooves (21, 25) and/or chutes, indentations and/or bridges, arranged to eliminate between the contact surfaces an uneven pressure distribution in the oil caused by a laminar oil flow.

2. Joint or bearing unit in accordance with claim 1,
characterized therein,
that the irregularities are constituted by indentations formed by films provided between the contact surfaces during compression of the outer part about the inner part during manufacture of the unit.

3. Joint or bearing unit in accordance wish claim 1 or 2,
characterized therein,
that the outer side of the outer ring (30A,30B,30C,30D) is designed with an optional outer contour adapted after an application for which the unit is intended.

4. Joint or bearing unit in accordance with anyone of the preceding claims,
characterized therein,
that the inner part (18,22,29) has a shape, which deviates from a sphere or a partial sphere and for instance is barrel-shaped (18) or elliptic (22), and which shape together with axial length of the contact surfaces can be utilized for adaption to the desired degree of sell-adjustment for the unit.
